(19) United States
(12) Patent Application Publication
(10) Pub. No.: US 2017/0113187 A1
(43) Pub. Date: Apr. 27, 2017

(54) METHOD FOR OPERATING SEPARATION MEMBRANE MODULE

(71) Applicant: TORAY INDUSTRIES, INC., Tokyo (JP)

(72) Inventors: Satoko KANAMORI, Shiga (JP); Aya NISHIO, Shiga (JP); Norihiro TAKEUCHI, Shiga (JP)

(73) Assignee: TORAY INDUSTRIES, INC., Tokyo (JP)

(21) Appl. No.: 15/128,798

(22) PCT Filed: Mar. 24, 2015
(86) PCT No.: PCT/JP2015/058942

§ 371 Date: Sep. 23, 2016

(30) Foreign Application Priority Data
Mar. 24, 2014 (JP) 2014-060640

(51) Int. Cl. B01D 65/02; B01D 61/14; C02F 1/44; B01D 63/02

(52) U.S. Cl. CPC B01D 65/02; B01D 63/02; B01D 61/14; C02F 1/444; C02F 2303/16; B01D 2321/162; B01D 2321/04

(57) ABSTRACT

The present invention relates to a method for operating a separation membrane module including a separation membrane having a first face and a second face, a liquid-to-be-filtrated flow channel along which liquid to be filtrated which is to be fed to the first face flows, and a permeated-liquid flow channel along which permeated liquid obtained from the second face flows, the method including: a filtration step of obtaining permeated liquid containing components that become insoluble when coming into contact with acids by feeding liquid to be filtrated to the liquid-to-be-filtrated flow channel; a first water substitution step of substituting liquid in the permeated-liquid flow channel with water, after the filtration step; a first chemical cleaning step of performing backwashing by causing an acidic chemical solution to flow from the second face toward the first face of the separation membrane, after the first water substitution step; and a second water substitution step of substituting liquid in the permeated-liquid flow channel with water, after the first chemical cleaning step.

### TECHNICAL FIELD

The present invention relates to a method for operating a separation membrane module, including filtrating liquid in which permeated liquid thereof obtained by filtrating with a separation membrane contains a component that becomes insoluble when coming into contact with an acid.

### BACKGROUND ART

Since separation of substances using separation membranes enables selective separation, condensation of substances, and removal of foreign substances from liquid, using the sizes or properties of substances without performing phase separation, separation of substances using separation membranes has been used for processes in a broadening range of various fields such as, mainly the water treatment field, production or brewing of foods and beverages, production of medicinal products, and production of medicinal water.

Thus far, mainly in the water treatment field, separation membrane modules have been used to filtrate liquid to be filtrated such as seawater, groundwater, and industrial wastewater including solutes such as ions and salts, thereby producing domestic water, industrial water, agricultural water, and the like. As filtration membranes in separation membrane modules which perform filtration, microfiltration membranes or ultrafiltration membranes are used, but substances that are not capable of passing through pores in separation membranes gradually deposit as fouling-causing substances, and filtration membranes are clogged.

When this clogging proceeds, the pressure difference between the side of a separation membrane on which liquid to be filtrated flows in (primary side) and the side on which filtrated water flows out (secondary side) gradually increases, and consequently, the permeate flux (flux) of the separation membrane decreases, or the output of pumps for feeding liquid to be filtrated to the membrane module increases.

Since the clogging of filtration membranes proceeds more rapidly as the permeate flux increases, clogging can be suppressed by decreasing the flux; however, instead, a decrease in the flux increases the number of necessary separation membranes, increases membrane exchange costs and the number of chemicals used for membrane cleaning and devices such as pumps necessary for operation, whereby costs and energy increase.

Therefore, in order to solve the clogging of filtration membranes and realize long-term stable filtration, a variety of membrane separation operation techniques have been developed. For example, air scrubbing in which the surfaces of separation membranes are physically cleaned by feeding air from an air diffuser disposed in the lower part of a separation membrane module (for example, refer to Patent Document 1) and flushing in which liquid to be filtrated or chemical solutions are caused to flow at a high linear speed on the surfaces of separation membranes (for example, refer to Patent Document 2) are disclosed.

In addition, examples of the membrane separation operation techniques include backpressure washing (hereinafter, in some cases, referred to as “backwashing”) in which contaminations in separation membranes are pushed out by performing filtration in a direction opposite to the membrane filtration, that is, from the secondary side to the primary side, and chemical solution backwashing in which backwashing is performed using chemical solutions instead of filtrate. For example, when filtration is performed using hollow-fiber membranes in methods for producing purified water, in order to solve clogging caused by contaminations inside of membranes, a method in which backwashing is performed using chemical solutions, and furthermore, a method in which the backwashing effect is enhanced by removing liquid to be filtrated in separation membrane modules before backwashing using chemical solutions have been proposed (for example, refer to Patent Document 3).

In addition, a method of performing backwashing using water first and then performing backwashing using chemical solutions, thereby enhancing the cleaning effect and decreasing the amount of the chemical solutions used has been disclosed (for example, refer to Patent Documents 4 and 5).

### BACKGROUND ART DOCUMENT

### Patent Document

Patent Document 1: JP-A-2006-255587

Patent Document 2: JP-A-2010-005615

Patent Document 3: JP-A-2004-057883

Patent Document 4: JP-A-2007-061697

Patent Document 5: JP-A-2007-330916

### SUMMARY OF THE INVENTION

### Problems that the Invention is to Solve

However, the operation methods described in Patent Documents 1 and 2 are effective to peel off contaminations deposited on the primary side surfaces of separation membranes but only have a weak effect with respect to contaminations deposited inside of separation membranes. On the other hand, in the operation methods described in Patent Documents 3, 4, and 5, contaminations in separation membranes can be pushed out, and, furthermore, a stronger cleaning effect can be obtained by performing backwashing using chemical solutions. These techniques are effective methods for the production of purified water; however, in food, beverage, and biotechnology fields, depending on aqueous solutions that are subjects of filtration and separation, there are cases in which, when acidic liquid is fed to flow channels or pipes on the permeated liquid side of separation membranes or to the inside of separation membranes during treatment operations, the components of the permeated liquid and acids come into contact with each other, and the clogging of the separation membranes are accelerated due to insoluble modified substances generated due to the above-described contact.

As described above, in the background art, when permeated liquid contains components that become insoluble when coming into contact with acids, long-term stable filtration operation cannot be realized, and thus there has been a demand for a method for operating separation membrane modules which is capable of continuing filtration for a long period of time while maintaining a large filtration amount per membrane area.

The present invention has been made in consideration of the above-described circumstances, and an object of the present invention is to provide a method for operating separation membranes, capable of stably filtrating liquid (liquid to be filtrated) in which obtained permeated liquid thereof contains a component that becomes insoluble when coming into contact with an acid, using a simple operation method.

### Means for Solving the Problems

As a result of intensive studies for solving the above-described problem and achieving the object, it has been found that it is possible to suppress the generation of modified substances of organic substances and stably perform membrane filtration for a long period of time without causing the clogging of separation membranes.

That is, a method for operating a separation membrane module of the present invention has the following constitutions [1] to [12].

[1] A method for operating a separation membrane module including a separation membrane having a first face and a second face, a liquid-to-be-filtrated flow channel along which liquid to be filtrated which is to be fed to the first face flows, and a permeated-liquid flow channel along which permeated liquid obtained from the second face flows, the method including:

a filtration step of obtaining permeated liquid containing components that become insoluble when coming into contact with acids from the second face of the separation membrane by feeding liquid to be filtrated to the liquid-to-be-filtrated flow channel;

a first water substitution step of substituting liquid in the permeated-liquid flow channel with water, after the filtration step;

a first chemical cleaning step of performing backwashing by causing an acidic chemical solution to flow from the second face toward the first face of the separation membrane, after the first water substitution step; and

a second water substitution step of substituting liquid in the permeated-liquid flow channel with water, after the first chemical cleaning step.

[2] The method for operating a separation membrane module according to [1], in which the first water substitution step includes causing water to flow from the second face toward the first face of the separation membrane.
[3] The method for operating a separation membrane module according to [1] or [2], further including:

a step of discharging liquid in the permeated-liquid flow channel, before the first chemical cleaning step.

[4] The method for operating a separation membrane module according to any one of [1] to [3], in which the permeated liquid has a total organic carbon (TOC) concentration of 100 ppm or higher and 400,000 ppm or lower.
[5] The method for operating a separation membrane module according to any one of [1] to [4], in which the permeated liquid has the total organic carbon (TOC) concentration of 100 ppm or higher and 400,000 ppm or lower, the liquid to be filtrated contains 100 g/L to 650 g/L of an organic substance, and the total organic carbon (TOC) concentration of the water to be used in the first water substitution step and the second water substitution step is 100 ppm or lower.
[6] The method for operating a separation membrane module according to any one of [1] to [5], in which the permeated liquid contains at least one substance selected from the group consisting of protein, polysaccharides and aromatic compounds.
[7] The method for operating a separation membrane module according to any one of [1] to [6], in which the liquid to be filtrated contains divalent or higher metal ions and contains at least one of polysaccharides and aromatic compounds.
[8] The method for operating a separation membrane module according to [7], in which, in the liquid to be filtrated, the metal ions and the at least one of polysaccharides and aromatic compounds form a complex.
[9] The method for operating a separation membrane module according to any one of [1] to [8], in which the acidic chemical solution is an aqueous solution which contains at least one compound selected from the group consisting of hydrochloric acid, nitric acid, sulfuric acid, phosphoric acid, formic acid, acetic acid, propionic acid, butyric acid, citric acid, oxalic acid, ascorbic acid and lactic acid, and has a pH of 1 or higher and 3 or lower.
[10] The method for operating a separation membrane module according to any one of [1] to [9], further including:

a second chemical cleaning step of causing an alkaline chemical solution to flow from the second face toward the first face of the separation membrane, after the second water substitution step; and

a third water substitution step of substituting liquid in the permeated-liquid flow channel with water, after the second chemical cleaning step.

[11] The method for operating a separation membrane module according to any one of [1] to [10], in which temperatures of the water to be used in the first water substitution step and the second water substitution step and the chemical solution to be used in the first chemical cleaning step are 35° C. or higher and 90° C. or lower.
[12] A device for performing the method for operating a separation membrane module according to any one of [1] to [11].

### Advantage of the Invention

According to the present invention, when performing a membrane filtration operation of liquid (liquid to be filtrated) in which permeated liquid thereof obtained by filtrating with a separation membrane contains a component that becomes insoluble when coming into contact with an acid, the contact between organic substances and chemical solutions is suppressed by performing a first water substitution step and a second water substitution step using water before and after a first chemical cleaning step using chemical solutions. As a result, the clogging of membranes caused by the generation of modified substances is reduced, a chemical solution cleaning effect is sufficiently exhibited, and long-term stable membrane filtration operation can be realized.

### BRIEF DESCRIPTION OF THE DRAWINGS

FIG. 1 is a flowchart exemplifying an embodiment of an operation method of the present invention.

FIG. 2 is a flowchart exemplifying another embodiment of the operation method of the present invention.

FIG. 3 is a schematic view illustrating an example of a membrane separation device that is used in an operation method of the present invention.

FIG. 4 is a schematic view illustrating another example of the membrane separation device that is used in the operation method of the present invention.

FIG. 5 is a view of changes in transmembrane pressures in Example 1 and Comparative Examples 1 to 5, 7, and 8.

FIG. 6 is a schematic view illustrating still another example of the membrane separation device that is used in the operation method of the present invention.

FIG. 7 is a schematic view illustrating still another example of the membrane separation device that is used in the operation method of the present invention.

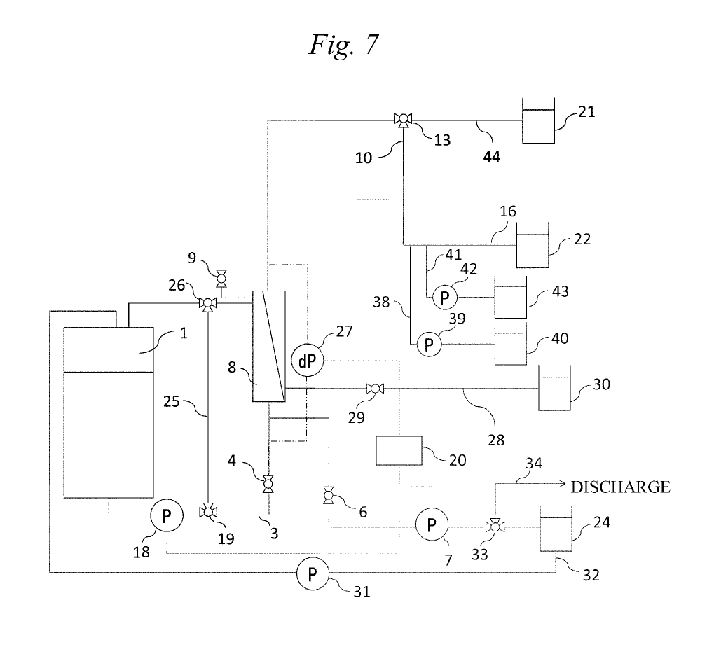

FIG. 8 is a view of changes in transmembrane pressures in Examples 1, 7, and 8 and Comparative Example 6.

### MODE FOR CARRYING OUT THE INVENTION

Hereinafter, a method for operating a separation membrane module according to an embodiment of the present invention will be described in detail on the basis of the accompanying drawings. Meanwhile, the present invention is not limited by the present embodiment.

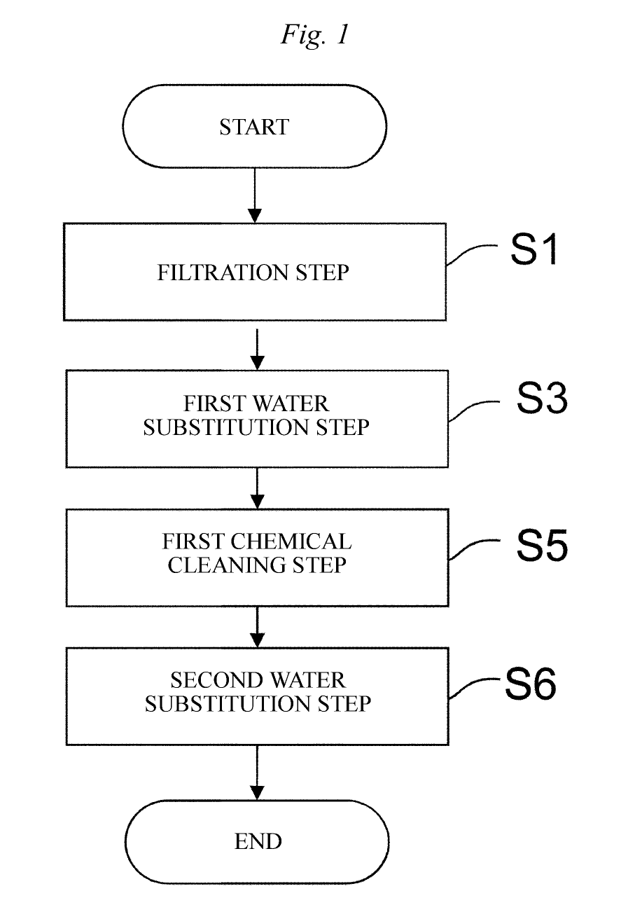

A method for operating a separation membrane module of the present invention is a method for operating a separation membrane module including a separation membrane having a first face and a second face, a liquid-to-be-filtrated flow channel along which liquid to be filtrated which is to be fed to the first face flows, and a permeated-liquid flow channel along which permeated liquid obtained from the second face flows, is an operation method in which permeated liquid is obtained by membrane-filtrating liquid to be filtrated, and includes, as illustrated in FIG. 1, a filtration step S1, a first water substitution step S3, a first chemical cleaning step S5, and a second water substitution step S6.

Meanwhile, in the drawings, “END” means that the operation of the separation membrane module ends or the process returns to “START” and the filtration step S1 is performed.

In the filtration step S1, liquid to be filtrated is fed to the first face of the separation membrane through the liquid-to-be-filtrated flow channel in the separation membrane module, and permeated liquid is obtained from the second face of the separation membrane. In the first water substitution step S3, liquid in the permeated-liquid flow channel is substituted with water. In the first chemical cleaning step S5, a chemical solution is caused to flow from the second face of the separation membrane toward the first face of the separation membrane, thereby performing backwashing. In the second water substitution step S6, liquid in the permeated-liquid flow channel is substituted with water. Meanwhile, the permeated-liquid flow channel refers to a pipe from the separation membrane module through a permeated liquid/permeated-liquid flow channel substitution water switching valve and a flow channel that comes into contact with the second face of the membrane in the separation membrane module.

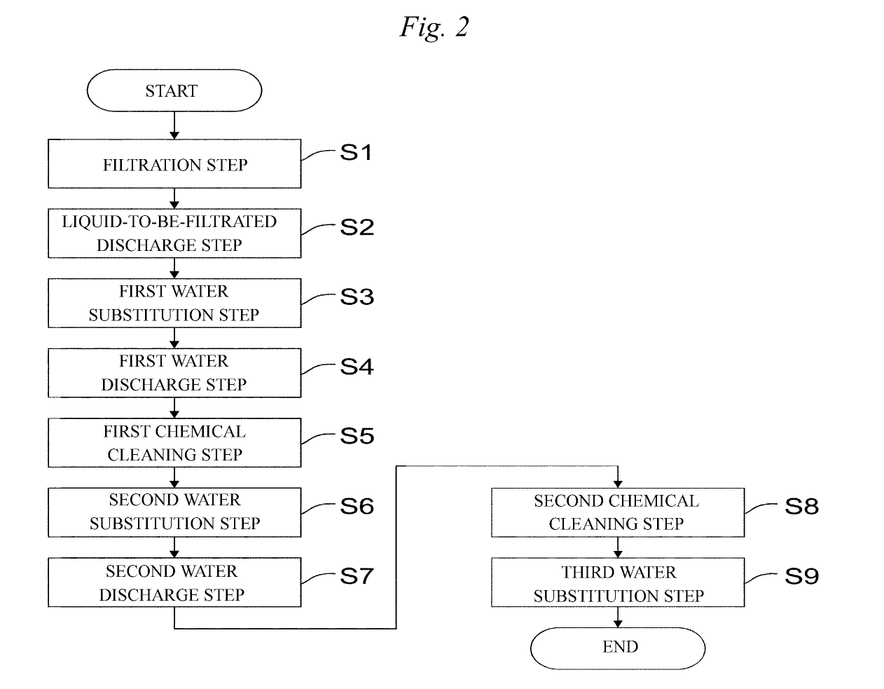

In addition, in a case where the first water substitution step is water substitution by means of backwashing, the method for operating a separation membrane module can arbitrarily include a first water discharge step S4 as illustrated in FIG. 2. The first water discharge step S4 is a step for discharging cleaning water which comes into contact with the first face of the separation membrane in the separation membrane module between the first water substitution step S3 and the first chemical cleaning step S5.

In addition, the method for operating a separation membrane module can arbitrarily include any one of a liquid-to-be-filtrated discharge step S2 and a second water discharge step S7 or both water discharge steps as illustrated in FIG. 2. The liquid-to-be-filtrated discharge step S2 is a step for discharging liquid to be filtrated which is present in the liquid-to-be-filtrated flow channel in the separation membrane module between the filtration step S1 and the first water substitution step S3. The second water discharge step S7 is a step for discharging cleaning water which is present in the liquid-to-be-filtrated flow channel in the separation membrane module after the second water substitution step S6.

The method for operating a separation membrane module of the present invention preferably includes the filtration step S1, the first water substitution step S3, the first water discharge step S4, the first chemical cleaning step S5, and the second water substitution step S6. The method for operating a separation membrane module more preferably includes the filtration step S1, the liquid-to-be-filtrated discharge step S2, the first water substitution step S3, the first water discharge step S4, the first chemical cleaning step S5, the second water substitution step S6, and the second water discharge step S7.

1. Separation Membrane Module

As the separation membrane module, well-known constitutions in the art can be applied.

The separation membrane module includes a separation membrane. In addition, the separation membrane module may include a mechanism capable of performing filtration and backwashing on the basis of size separation instead of membranes. For example, sand filtration or filter cloth filtration can also be used.

The separation membrane may be an organic membrane or an inorganic membrane as long as the membrane is capable of backwashing, and examples thereof include polyvinylidene fluoride membranes, polysulfone membranes, polyether sulfone membranes, polytetrafluoroethylene membranes, polyethylene membranes, polypropylene membranes, and ceramic membranes. Particularly, polyvinylidene fluoride separation membranes which are not easily contaminated due to organic substances, can be easily cleaned, and, furthermore, have excellent durability are preferred.

The separation membrane may be a microfiltration membrane or an ultrafiltration membrane. The fine pore diameters in the separation membrane are not particularly limited and can be appropriately selected from a range of 0.001 μm or larger and smaller than 10 μm in order to preferably separate suspensoid and dissolved components in liquid to be filtrated. The average fine pore diameter of the membrane is determined according to the method (also called a half dry method) described in ASTM: F316-86. Meanwhile, the average fine pore diameter determined using this half dry method is the average pore diameter of the layer with the minimum pore diameter in the separation membrane.

The standard measurement conditions for the measurement of the average fine pore diameter using the half dry method are ethanol as liquid to be used, 25° C. as the measurement temperature, and 1 kPa/second as the pressure-rise rate. The average fine pore diameter [μm] is determined using the following expression.

Average fine pore diameter [μm]=(2860×surface tension [mN/m])/half dry air pressure [Pa]

Since the surface tension of ethanol at 25° C. is 21.97 mN/m (The Chemical Society of Japan, the 3rd revised basic edition of Chemistry Handbook, page II-82, Maruzen Publishing Co., Ltd., 1984), in the case of the standard measurement conditions, the average fine pore diameter can be obtained from:

average fine pore diameter [μm]=62834.2/half dry air pressure [Pa].

In addition, regarding the shape of the separation membrane, it is possible to employ a separation membrane having any shape such as a hollow-fiber membrane, a tubular membrane, a monolith membrane, or a pleated membrane as long as the membrane is capable of backwashing, but a hollow-fiber membrane having a large membrane area with respect to the volume of the separation membrane module is preferred.

The hollow-fiber membrane may be any one of an external pressure-type hollow-fiber membrane in which filtration is performed from the outside toward the inside of the hollow-fiber and an internal pressure-type hollow-fiber membrane in which filtration is performed from the inside toward the outside of the hollow-fiber, but the external pressure-type hollow-fiber membrane in which clogging is not easily caused due to suspensoid is more preferred. For the external pressure-type hollow-fiber membrane, the outer diameter of the hollow-fiber is desirably 0.5 mm or larger and 3 mm or smaller. When the outer diameter thereof is 0.5 mm or larger, the resistance of permeated liquid which flows in the hollow-fiber membrane can be suppressed to a relatively small extent. In addition, when the outer diameter is 3 mm or smaller, it is possible to suppress the hollow-fiber membrane being collapsed due to liquid to be filtrated. In addition, for the internal pressure-type hollow-fiber membrane, the inner diameter thereof is desirably 0.5 mm or larger and 3 mm or smaller. When the inner diameter is 0.5 mm or larger, the resistance of liquid to be filtrated which flows in the hollow-fiber membrane can be suppressed to a relatively small extent. In addition, when the inner diameter is 3 mm or smaller, the membrane surface area can be ensured, and thus it is possible to suppress the number of modules to be used.

The separation membrane module can include a variety of members in addition to the separation membrane. For example, the separation membrane module may include a housing that covers the periphery of the separation membrane; an introduction opening that guides liquid to be filtrated to the inside of the housing, a concentrate discharge opening that discharges concentrate, a permeated liquid discharge opening that discharges permeated liquid, and the like.

2. Method for Operating Separation Membrane Module

In the present invention, the method for operating a separation membrane module is a method for operating a separation membrane module including a separation membrane having a first face and a second face, a liquid-to-be-filtrated flow channel along which liquid to be filtrated which is to be fed to the first face flows, and a permeated-liquid flow channel along which permeated liquid obtained from the second face flows, in which the following steps S1, S3, S5, and S6 are sequentially performed:

(a) A filtration step S1 in which liquid to be filtrated is introduced into the first face of the separation membrane through the liquid-to-be-filtrated flow channel, and permeated liquid containing components that become insoluble when coming into contact with acids is obtained from the second face of the separation membrane;

(b) A first water substitution step S3 in which liquid in the permeated-liquid flow channel in the separation membrane is substituted with water;

(c) A first chemical cleaning step S5 in which an acidic chemical solution is caused to flow from the second face toward the first face of the separation membrane; and

(d) A second water substitution step S6 in which liquid in the permeated-liquid flow channel in the separation membrane is substituted with water.

The respective steps will be described below.

2-1. Filtration Step

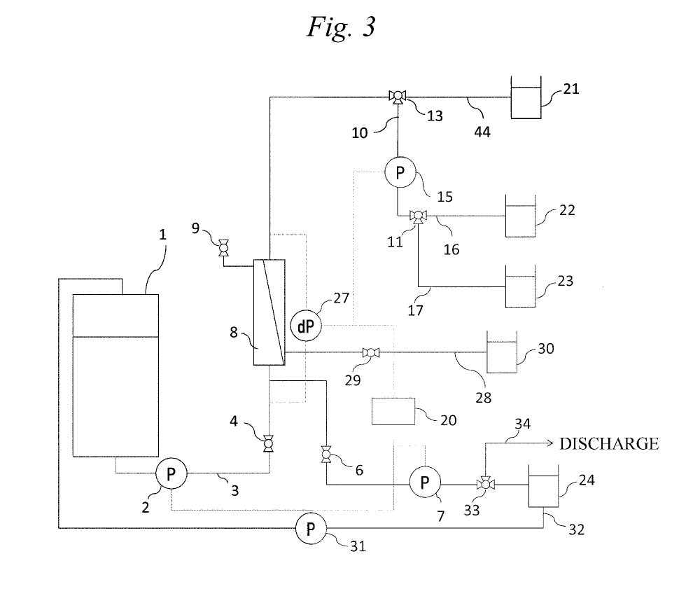

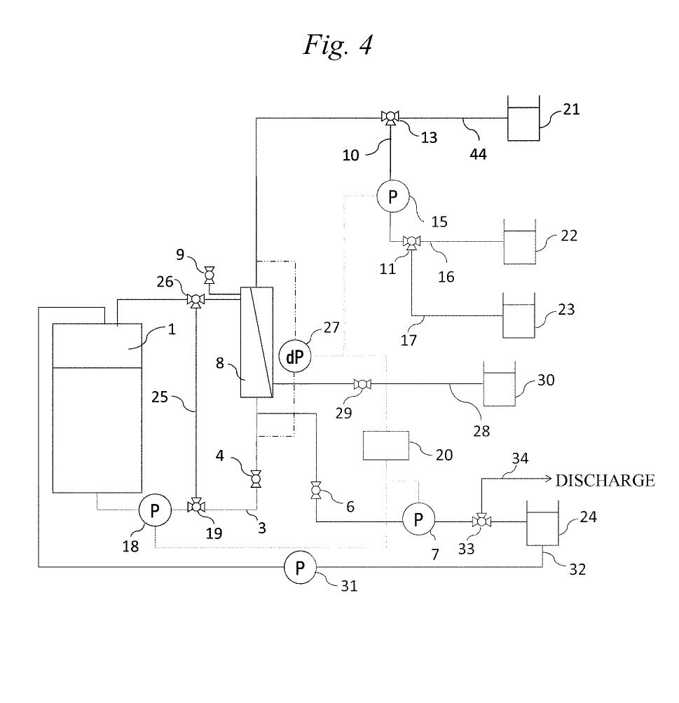

An example of a filtration device in which the separation membrane module is used will be described with reference to FIGS. 3 and 4. FIG. 3 is a schematic view of a membrane separation device that is used when dead-end filtration is performed in the operation method of the present invention, and FIG. 4 a schematic view of a membrane separation device that is used when cross-flow filtration is performed in the operation method of the present invention.

In the filtration step S1, liquid to be filtrated flows in from the first face of a separation membrane module 8, and filtrated permeated liquid flows out from the second face. Specifically, in FIG. 3, the liquid to be filtrated is pulled off from a liquid-to-be-filtrated feed tank 1 and is fed to the separation membrane module 8 through a pipe 3. The liquid to be filtrated is filtrated with the separation membrane module 8 and is separated into concentrated liquid and permeated liquid. The permeated liquid is sent to a permeated liquid tank 21 through a permeated liquid/permeated-liquid flow channel substitution water switching valve 13 and a permeated-liquid flow channel 44. In the dead-end filtration, the concentrated liquid remains on the primary side (inflow side) of the membrane. In addition, in the cross-flow filtration, the concentrated liquid is discharged to the outside of the separation membrane module 8 through a cross-flow switching valve 26 and is refluxed to the liquid-to-be-filtrated feed tank 1.

The driving force for filtration may be obtained using a siphon in which the liquid level difference (water head difference) between the liquid-to-be-filtrated feed tank 1 and the separation membrane module 8 is used or may be obtained using a transmembrane pressure generated due to pressurization using a filtration pump 2 in FIG. 3. In addition, as the driving force for filtration, a suction pump (filtration pump) may be installed on the permeated-liquid flow channel side of the separation membrane module 8. The example of FIG. 3 is an example in which the filtration pump 2 is disposed in the liquid-to-be-filtrated flow channel in the separation membrane module 8.

Filtration can be performed continuously or intermittently. In a case where filtration is performed intermittently, it is possible to halt the filtration for a predetermined period of time (for example, for 0.1 minutes to 30 minutes) every 5 minutes to 120 minutes during which the filtration is continuously performed. More preferably, the filtration may be halted for 0.25 minutes to 10 minutes every 10 minutes to 30 minutes during which the filtration is continuously performed.

During the period of time in which the filtration is halted, the first water substitution step S3, the first chemical cleaning step S5, and the second water substitution step S6, and, arbitrarily, the first water discharge step S4, the liquid-to-be-filtrated discharge step S2, and the second water discharge step S7, all of which will be described below, may be performed. In addition, during the period of time in which the filtration is halted, only the first water substitution step S3 and/or the liquid-to-be-filtrated discharge step S2 may be performed. Regarding a criterion for performing the first chemical cleaning step S5 and the second water substitution step S6, it is possible to use the transmembrane pressure between the first face and the second face of the separation membrane in the separation membrane module 8 as the criterion. In the present invention, when the transmembrane pressure is preferably in a range of 10 to 100 kPa and more preferably in a range of 15 to 50 kPa, the first chemical cleaning step S5 and the second water substitution step S6 may be performed. The transmembrane pressure can be measured using a differential pressure meter 27.

The method for controlling the filtration flow rate may be either constant flow filtration or constant pressure filtration, but constant flow filtration is preferred from the viewpoint of ease of controlling the production amount of permeated liquid.

2-2. First Water Substitution Step

In the operation method of the present invention, subsequent to the filtration step S1, the first water substitution step S3 of backwashing the separation membrane is performed. With this step, the liquid to be filtrated remaining in the permeated-liquid flow channel or the separation membrane module can be easily substituted with water. Therefore, in the first chemical cleaning step S5 described below, components that become insoluble when coming into contact with chemical solutions or acids in the permeated liquid do not come into contact with acids, and the separation membrane can be backwashed using chemical solutions. In the constitution of FIG. 3, a pipe 10 is connected to the permeated-liquid flow channel 44, and permeated-liquid flow channel substitution water is injected into the separation membrane module 8 using a permeated-liquid flow channel substitution water pump 15.

In addition, a permeated-liquid flow channel substitution water pipe 16 and an acidic chemical solution pipe 17 are connected to the pipe 10 through a permeated-liquid flow channel substitution water/acidic chemical solution switching valve 11. A permeated-liquid flow channel substitution water feed source 22 and an acidic chemical solution tank 23 are respectively connected to the permeated-liquid flow channel substitution water pipe 16 and the acidic chemical solution pipe 17.

The kinds of water that is fed from the permeated-liquid flow channel substitution water feed source 22 are not particularly limited as long as the TOC concentration is 100 ppm or lower, and examples thereof include distilled water, ion-exchange water, and reverse osmosis filtrate.

While the first water substitution step S3 is performed, the filtration is halted in order to prevent permeated-liquid flow channel substitution water from flowing into the permeated liquid tank 21 which retains permeated liquid. That is, the permeated liquid/permeated-liquid flow channel substitution water switching valve 13 is opened on the permeated-liquid flow channel substitution water pipe 16 side and is closed on the permeated liquid tank 21 side, and the filtration pump 2 stops. In this state, a discharge valve 9 is opened, a permeated-liquid flow channel substitution water/acidic chemical solution switching valve 11 is opened on the permeated-liquid flow channel substitution water feed source 22 side and is closed on the acidic chemical solution tank 23 side, and the permeated-liquid flow channel substitution water pump 15 is run, thereby performing water substitution in the permeated-liquid flow channel.

The first water substitution step S3 may be performed for a period of time long enough to substitute the permeated-liquid flow channel with which a chemical solution comes into contact in the subsequent first chemical cleaning step S5.

The period of time for performing the first water substitution step can be controlled using the control device 20. In order to determine the starting time and the ending time of backwashing, the membrane separation device may include a measuring instrument such as a timer that is not illustrated. In addition, the first water substitution step S3 may be backwashing in which the permeated-liquid flow channel substitution water flows from the second face to the first face of the separation membrane.

2-3. First Chemical Cleaning Step

In the operation method of the present invention, after the first water substitution step S3, the first chemical cleaning step S5 in which the separation membrane is backwashed using a chemical solution is performed.

When the first chemical cleaning step S5 is performed, in the state of the first water substitution step S3, the permeated-liquid flow channel substitution water/acidic chemical solution switching valve 11 is closed on the permeated-liquid flow channel substitution water feed source 22 side and is opened on the acidic chemical solution tank 23 side, thereby performing backwashing using an acidic chemical solution.

The period of time during which the first chemical cleaning step S5 is performed is preferably in a range of approximately 30 seconds to 30 minutes. This is because, when the step is performed for a long period of time, the period of time during which the filtration is halted becomes long, which decreases the operation efficiency, and the amount of chemical solutions being used increases, which makes the step economically disadvantageous. Furthermore, for the same reasons, the period of time is more preferably in a range of approximately 30 seconds to 10 minutes. In addition, the period of time may be shortened or extended depending on the clogging of the separation membrane which is estimated from the transmembrane pressure.

2-4. Second Water Substitution Step

In the operation method of the present invention, subsequent to the first chemical cleaning step S5, the second water substitution step S6 of backwashing the permeated-liquid flow channel using water is performed. With this step, it is possible to perform a rinse to wash the chemical solution remaining in the permeated-liquid flow channel, the generation of modified substances due to the contact between the permeated liquid and the chemical solution and the infusion of the chemical solution into the permeated liquid do not occur, and it is possible to resume the filtration. In addition, this second water substitution step S6 may be backwashing in which the permeated-liquid flow channel substitution water flows from the second face to the first face of the separation membrane.

When the second water substitution step S6 is performed, in the state of the first chemical cleaning step S5, the permeated-liquid flow channel substitution water/acidic chemical solution switching valve 11 is opened on the permeated-liquid flow channel substitution water feed source 22 side and is closed on the acidic chemical solution tank 23 side, thereby performing substitution of liquid in the permeated-liquid flow channel with permeated-liquid flow channel substitution water. When the second water substitution step S6 is halted, the permeated-liquid flow channel substitution water pump 15 stops. In this state, the discharge valve 9 is closed, a filtration valve 4 is opened, the permeated liquid/permeated-liquid flow channel substitution water switching valve 13 is opened on the permeated liquid tank 21 side and is closed on the permeated-liquid flow channel substitution water feed source 22 side, and the filtration pump 2 is run, thereby performing the filtration step S1.

The second water substitution step S6 may be performed for a period of time long enough to substitute the permeated-liquid flow channel with which the chemical solution has come into contact in the precedent first chemical cleaning step S5.

2-5. First Water Discharge Step

In the operation method of the present invention, after the first water substitution step S3 and before the first chemical cleaning step S5, the first water discharge step S4 of discharging liquid remaining on the first face side of the separation membrane in the separation membrane module 8 may be performed. Specifically, in FIG. 3, the permeated-liquid flow channel substitution water pump 15 is stopped, and a suspensoid discharge valve 6 and the discharge valve 9 are opened, whereby liquid remaining in the separation membrane module 8 is discharged to the outside of the separation membrane module 8. Liquid may be discharged by means of free fall due to gravity or using a suction pump 7. The discharged liquid may be discarded as discharged water through a discharged water/discharged suspensoid liquid storage tank switching valve 33 or may be collected in a discharged suspensoid liquid storage tank 24 and reused. The collected liquid may be refluxed to the liquid-to-be-filtrated feed tank 1 through a discharged suspensoid liquid reflux pipe 32 using a discharged suspensoid liquid reflux pump 31. Subsequently, the suspensoid discharge valve 6 is opened, and the permeated-liquid flow channel substitution water/acidic chemical solution switching valve 11 is opened on the permeated-liquid flow channel substitution water feed source 22 side and is closed on the acidic chemical solution tank 23 side, thereby starting the first chemical cleaning step S5. Due to the first water discharge step S4 performed, in the first chemical cleaning step S5, the concentration of the chemical solution near the membrane surfaces is maintained at a high level, backwashing using the acidic chemical solution is efficiently performed, and the amount of the acidic chemical solution required can be decreased.

2-6. Liquid-to-be-Filtrated Discharge Step

In the operation method of the present invention, subsequent to the filtration step S1 and before the first water substitution step S3, the liquid-to-be-filtrated discharge step S2 of discharging liquid remaining on the primary side of the separation membrane may be performed. Specifically, in FIG. 3, the filtration valve 4 is closed, and the filtration pump 2 is stopped. In this state, the suspensoid discharge valve 6 and the discharge valve 9 are opened, whereby the liquid to be filtrated remaining in the separation membrane module 8 is discharged to the outside of the separation membrane module 8. The liquid may be discharged by means of free fall due to gravity or using the suction pump 7. The discharged suspensoid liquid that has been discharged may be discarded as discharged water through the discharged water/discharged suspensoid liquid storage tank switching valve 33 or may be collected in the discharged suspensoid liquid storage tank 24 and reused. The collected liquid may be refluxed to the liquid-to-be-filtrated feed tank 1 through the discharged suspensoid liquid reflux pipe 32 using the discharged suspensoid liquid reflux pump 31. Subsequently, the suspensoid discharge valve 6 and the discharge valve 9 are closed, the permeated-liquid flow channel substitution water/acidic chemical solution switching valve 11 is opened on the permeated-liquid flow channel substitution water feed source 22 side and is closed on the acidic chemical solution tank 23 side, and the permeated-liquid flow channel substitution water pump 15 is run, thereby starting the first water substitution step S3. When the liquid-to-be-filtrated discharge step S2 is performed, it is possible to enhance the cleaning effect in the first water substitution step S3.

2-7. Second Water Discharge Step

In the operation method of the present invention, subsequent to the second water substitution step S6, the second water discharge step S7 of discharging liquid remaining on the first face side of the separation membrane in the separation membrane module 8 may be performed. Specifically, in FIG. 3, the permeated-liquid flow channel substitution water pump 15 is stopped, and the suspensoid discharge valve 6 and the discharge valve 9 are opened, whereby liquid remaining on the first face side of the separation membrane in the separation membrane module 8 is discharged to the outside of the separation membrane module 8. The liquid may be discharged by means of free fall due to gravity or using the suction pump 7.

The liquid discharged in the second water discharge step S7 may be discarded as discharged water through the discharged water/discharged suspensoid liquid storage tank switching valve 33 or may be collected in the discharged suspensoid liquid storage tank 24 and reused. In addition, the collected liquid may be refluxed to the liquid-to-be-filtrated feed tank 1 through the discharged suspensoid liquid reflux pipe 32 using the discharged suspensoid liquid reflux pump 31. Subsequently, the suspensoid discharge valve 6 and the discharge valve 9 are closed, the permeated liquid/permeated-liquid flow channel substitution water switching valve 13 is opened on the permeated liquid tank 21 side, and the filtration pump 2 is driven, thereby performing the filtration step S1. When the second water discharge step S7 is performed, it is possible to suppress the liquid to be filtrated being attenuated.

2-8. Second Chemical Cleaning Step S8 and Third Water Substitution Step S9

In the operation method of the present invention, the second chemical cleaning step S8 of causing an alkaline chemical solution to flow from the second face to the first face of the separation membrane may be performed after the second water substitution step S6, and a third water substitution step S9 of substituting the permeated-liquid flow channel in the separation membrane module with water may be performed after the second chemical cleaning step.

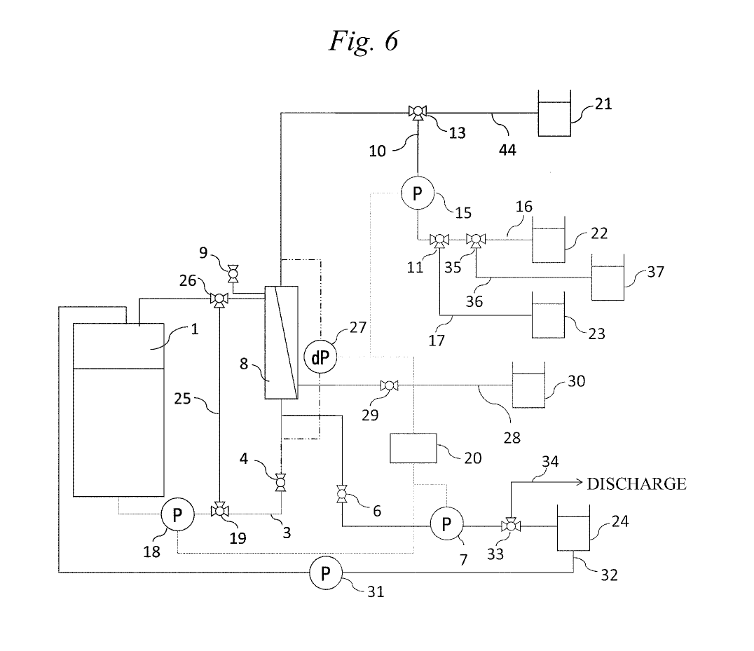

Specifically, first, in a constitution of FIG. 6, in a state of the second water substitution step S6, the permeated-liquid flow channel substitution water/acidic chemical solution switching valve 11 is opened on the permeated-liquid flow channel substitution water feed source 22 side and is closed on the acidic chemical solution tank 23 side, and a permeated-liquid flow channel substitution water/alkaline chemical solution switching valve 35 is opened in a direction toward an alkaline chemical solution tank 37, thereby performing the second chemical cleaning step S8. Subsequently, in a state of the second chemical cleaning step S8, the permeated-liquid flow channel substitution water/alkaline chemical solution switching valve 35 is opened on the permeated-liquid flow channel substitution water feed source 22 side and is closed on the alkaline chemical solution tank 37 side, thereby performing the third water substitution step S9. In this state, the discharge valve 9 is closed, the filtration valve 4 is opened, the permeated liquid/permeated-liquid flow channel substitution water switching valve 13 is opened on the permeated liquid tank 21 side and is closed on the permeated-liquid flow channel substitution water feed source 22 side, and the filtration pump 2 is driven, thereby performing the filtration step S1.

The period of time during which the second chemical cleaning step S8 is performed is preferably in a range of approximately 30 seconds to 30 minutes. This is because, when the step is performed for a long period of time, the period of time during which the filtration is halted becomes long, which decreases the operation efficiency, and the amount of chemical solutions being used increases, which makes the step economically disadvantageous. Furthermore, for the same reasons, the period of time is more preferably in a range of approximately 30 seconds to 10 minutes. In addition, the period of time may be shortened or extended depending on the clogging of the separation membrane which is estimated from the transmembrane pressure. In addition, the third water substitution step S9 may be performed for a period of time long enough to substitute water in the pipe and the separation membrane module with which the chemical solution has come into contact in the second chemical cleaning step S8.

When the third water substitution step S9 is performed, it is possible to perform a rinse to wash the alkaline chemical solution remaining in the separation membrane or the chemical solution attached to the separation membrane module in the second chemical cleaning step, the generation of modified substances due to the contact between the liquid to be filtrated or the permeated liquid and the chemical solution and the infusion of the chemical solution into the permeated liquid do not occur, and it is possible to resume the filtration.

3. Permeated Liquid

The permeated liquid that has permeated the separation membrane of the present invention contains components that become insoluble when coming into contact with acidic chemical solutions. Whether or not the permeated liquid contains components that become insoluble when coming into contact with acidic chemical solutions can be checked by, for example, dosing the same amount of an acidic chemical solution to the permeated liquid and confirming whether or not sinking fractions are generated when centrifugal separation is performed at 20,000 g. Alternatively, when liquid obtained by dosing the same amount of distilled water to the permeated liquid and liquid obtained by dosing the same amount of an acidic chemical solution to the permeated liquid are respectively filtrated using membrane filters having a molecular weight cut off of 3,000, and then the filters are dried, if the weight of the filter used for the liquid obtained by dosing the acidic chemical solution is heavier, it is possible to determine that the permeated liquid contains insoluble components.

In addition, the TOC concentration of the permeated liquid is preferably 100 ppm or higher and 400,000 ppm or lower and particularly preferably 400 ppm or higher and 360,000 ppm or lower. When the TOC concentration of the permeated liquid is lower than 100 ppm, the effect of performing the present invention is weak, and, when the TOC concentration exceeds 400,000 ppm, a sufficient cleaning effect cannot be obtained.

In addition, the permeated liquid preferably contains at least one substance selected from the group consisting of protein, polysaccharides, and aromatic compounds or decomposed substances thereof. Examples of the polysaccharides include cellulose, hemicellulose, starch, glycogen, agarose, pectin, mannan, carrageenan, guar gum, gelatin, and decomposed substances thereof. Whether or not the permeated liquid contains polysaccharides can be checked by, for example, for the permeated liquid and liquid obtained by adjusting the permeated liquid to be alkaline and then hydrolyzing the permeated liquid for 20 minutes at 121° C., measuring the amounts of monosaccharides contained therein by means of HPLC and confirming the difference in the content of monosaccharides between the permeated liquid and the hydrolyzed liquid. In addition, examples of the aromatic compounds include lignin, catechin, flavonoid, polyphenol, and decomposed substances thereof. Whether or not the permeated liquid contains the above-described substances can be measured using generally-known methods for measuring the respective substances.

4. Liquid to be Filtrated

The liquid to be filtrated which will be a separation subject is preferably an aqueous solution which contains divalent or higher metal ions and contains at least one of polysaccharides and aromatic compounds. Examples of the metal include zinc, iron, calcium, aluminum, magnesium, manganese, copper, and nickel. Examples of the polysaccharides include cellulose, hemicellulose, starch, glycogen, agarose, pectin, mannan, carrageenan, guar gum, gelatin, and decomposed substances thereof. Whether or not the liquid to be filtrated contains polysaccharides can be checked by, for example, for the liquid to be filtrated and liquid obtained by adjusting the liquid to be filtrated to be alkaline and then hydrolyzing the liquid to be filtrated for 20 minutes at 121° C., measuring the amounts of monosaccharides contained therein by means of HPLC and confirming the difference in the content of monosaccharides between the liquid to be filtrated and the hydrolyzed liquid. In addition, examples of the aromatic compounds include lignin, catechin, flavonoid, polyphenol, and decomposed substances thereof. Whether or not the liquid to be filtrated contains the above-described substances can be measured using generally-known methods for measuring the respective substances.

In addition, in the liquid to be filtrated, the metal ions and the at least one of polysaccharides and aromatic compounds preferably form a complex. When the metal ions and the at least one of polysaccharides and aromatic compounds form a complex in the liquid to be filtrated, it is possible to obtain a stronger permeability-recovering effect from the acidic chemical solution. Whether or not the complex has been formed can be checked by, for example, measuring the molecular weight distribution before and after the dosing of a chelate agent to the liquid to be filtrated, but the method is not limited thereto.

In addition, the liquid to be filtrated is a solution containing preferably 100 mg/L or more and more preferably 100 g/L to 650 g/L of an organic substance. The organic substance is mainly a saccharide such as a polysaccharide or an oligosaccharide, an aromatic compound, protein, or amino acid. Examples of the above-described liquid to be filtrated include squeezed juice and juice of fruits and vegetables, tea, milk, soy milk, milk serum, liquid preparations, alcoholic beverage such as beer, wine and sake, vinegar, soy sauce, fermentation liquor, glycosylated starch liquid, starch syrup, isomerized sugar syrup, aqueous solutions of oligo sugar, squeezed juice of sweet potato, sugar cane, and the like, honey, saccharified solutions of cellulose-containing biomass, infusion, seafood process-discharged water, and the like. Regarding the state of the organic substance, the organic substance may be dissolved in the liquid to be filtrated or may be present in a colloid or suspensoid form.

5. Acidic Chemical Solution

The acidic chemical solution is preferably an aqueous solution containing at least one compound selected from the group consisting of inorganic acids such as hydrochloric acid, nitric acid, sulfuric acid and phosphoric acid, and organic acids such as formic acid, acetic acid, propionic acid, butyric acid, citric acid, oxalic acid, ascorbic acid and lactic acid. In addition, the pH of the acidic aqueous solution is not particularly limited, but is preferably in a range of 0 to 5 and more preferably in a range of 1 to 3. When the pH of the acidic aqueous solution is set in the above-described range, it is possible to obtain a sufficient cleaning effect and extend the service lives of membranes.

The concentration of the chemical solution is preferably in a range of 10 mg/L to 200,000 mg/L. This is because, when the concentration of the chemical solution is lower than 10 mg/L, the cleaning effect is not sufficient, and, when the concentration thereof becomes higher than 200,000 mg/L, the cost of the chemical solution becomes high and is not economical. The chemical solution may be one kind of chemical solution or a mixture of two or more kinds of chemical solutions.

6. Alkaline Chemical Solution

The alkaline chemical solution is preferably an aqueous solution containing at least one compound selected from the group consisting of sodium hydroxide, potassium hydroxide, ammonia water, and sodium hydrogen carbonate. In addition, the alkaline chemical solution may contain, in addition to the above-described alkaline compound, an oxidant, for example, sodium hypochlorite. In addition, the pH of the alkaline aqueous solution is preferably in a range of 9 to 14 and more preferably in a range of 10 to 12. When the pH of the alkaline aqueous solution is set in the above-described range, it is possible to obtain a sufficient cleaning effect and extend the service lives of membranes.

7. Temperatures

The temperatures of the water to be used in the first water substitution step and the second water substitution step, the acidic chemical solution to be used in the first chemical cleaning step, and/or the alkaline chemical solution to be used in the second chemical cleaning step are preferably 20° C. or higher and 97° C. or lower and more preferably 35° C. or higher and 95° C. or lower. When the temperatures of the water and the chemical solutions being used are set in the above-described ranges, it is possible to obtain a sufficient cleaning effect.

8. Dead-End Filtration and Cross-Flow Filtration

Filtration that is performed in the separation membrane module may be dead-end filtration or cross-flow filtration. However, for liquid to be filtrated containing organic substances at a high concentration, a large amount of contaminations are attached to the separation membrane, and thus cross-flow filtration is preferably performed in order to effectively remove these contaminations. This is because, in cross-flow filtration, it is possible to remove contaminations being attached to membranes using the shearing force of the liquid to be filtrated being circulated.

A schematic view of a membrane filtration device in a case of performing cross-flow filtration is exemplified in FIG. 4. The driving force for filtration is obtained from transmembrane pressure that is obtained using a cross-flow filtration circulation pump 18. During cross-flow circulation, the liquid to be filtrated that has been taken out from the liquid-to-be-filtrated feed tank 1 is fed to the separation membrane module 8 using the cross-flow filtration circulation pump 18, is caused to flow along the surface of the separation membrane, and is membrane-filtrated. Concentrate that has failed to permeate the separation membrane is discharged from the separation membrane module 8 and is returned to the liquid-to-be-filtrated feed tank 1.

In the first water discharge step S4, the liquid-to-be-filtrated discharge step S2, and the second water discharge step S7, the feed of the liquid to be filtrated to the separation membrane module 8 is halted. At this time, the cross-flow stream of the liquid to be filtrated preferably flows in a bypass line 25 that is disposed in parallel with the separation membrane module 8. Specifically, cross-flow switching valves 19 and 26 illustrated in FIG. 4 are closed on the separation membrane module 8 side and are opened on the bypass line 25 side, and cross-flow circulation is performed in the bypass line 25. With this performance, it is possible to decrease the number of times of the operation/halting of the cross-flow filtration circulation pump 18. When cross-flow circulation in which the liquid to be filtrated is fed to the separation membrane module 8 resumes, the cross-flow switching valves 19 and 26 are opened on the separation membrane module 8 side and are closed on the bypass line 25 side. In such a case, cross-flow circulation in which the liquid to be filtrated is fed to the separation membrane module 8 and concentrate being discharged from the separation membrane module 8 is returned to the liquid-to-be-filtrated feed tank 1 is resumed.

In the first water substitution step S3, the first chemical cleaning step S5, and the second water substitution step S6, the feed of the liquid to be filtrated to the separation membrane module 8 may or may not be halted. However, it is preferable to halt the circulation of the cross-flow stream returning to the liquid-to-be-filtrated feed tank 1 from the separation membrane module 8. At this time, the cross-flow stream of the liquid to be filtrated flowing out from the liquid-to-be-filtrated feed tank 1 preferably flows in the bypass line 25. Specifically, the cross-flow switching valves 19 and 26 illustrated in FIG. 4 are closed on the separation membrane module 8 side and are opened on the bypass line 25 side, and cross-flow circulation is performed in the bypass line 25. In such a case, it is possible to decrease the number of times of the operation/halting of the cross-flow filtration circulation pump 18. When cross-flow circulation to the separation membrane module 8 resumes, the cross-flow switching valves 19 and 26 are opened on the separation membrane module 8 side and are closed on the bypass line 25 side, whereby the liquid to be filtrated is fed to the separation membrane module 8, and cross-flow circulation in which concentrate being discharged from the separation membrane module 8 is returned to the liquid-to-be-filtrated feed tank 1 is resumed.

### EXAMPLES

Hereinafter, the present invention will be specifically described using Examples and Comparative Examples, but the present invention is not limited to Examples.

### Example 1

A cellulose-containing biomass-derived sugar syrup was filtrated using a membrane separation device illustrated in FIG. 4. As a separation membrane, a polyvinylidene fluoride hollow-fiber membrane having a nominal fine pore diameter of 0.05 μm which was used in a microfiltration membrane module “TORAYFIL” (registered trademark) HFS manufactured by Toray Industries, Inc. was cut out, and a hollow-fiber membrane module obtained by accommodating the separation membrane in a molded polycarbonate resin product was used.

The cellulose-containing biomass-derived sugar syrup was obtained according to the following order. First, 2,940 g of distilled water and 60 g of strong sulfuric acid were dosed to and were suspended in 400 g of a rice straw and were subjected to an autoclave treatment at 15° C. for 30 minutes using an autoclave (manufactured by Nitto Koatsu Co., Ltd.). After the treatment, a liquid mixture having a pH that had been adjusted to near five using sodium hydroxide was obtained. Subsequently, 250 g of an enzyme aqueous solution containing a total of 25 g of TRICHODERMA CELLULOSE (manufactured by Sigma-Aldrich Co. LLC.) and NOVOZYME 188 (aspergillus niger-derived β glycosidase preparation, manufactured by Sigma-Aldrich Co. LLC.) was prepared and dosed to the above-described liquid mixture, the components were stirred and mixed together at 50° C. for three days, and supernatants generated after leaving the mixture for a while were subjected to filtration. The sugar syrup had a zinc ion concentration of 1,200 ppm, a polysaccharide concentration of 5 g/L, and a protein concentration of 10 g/L.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed for two minutes.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

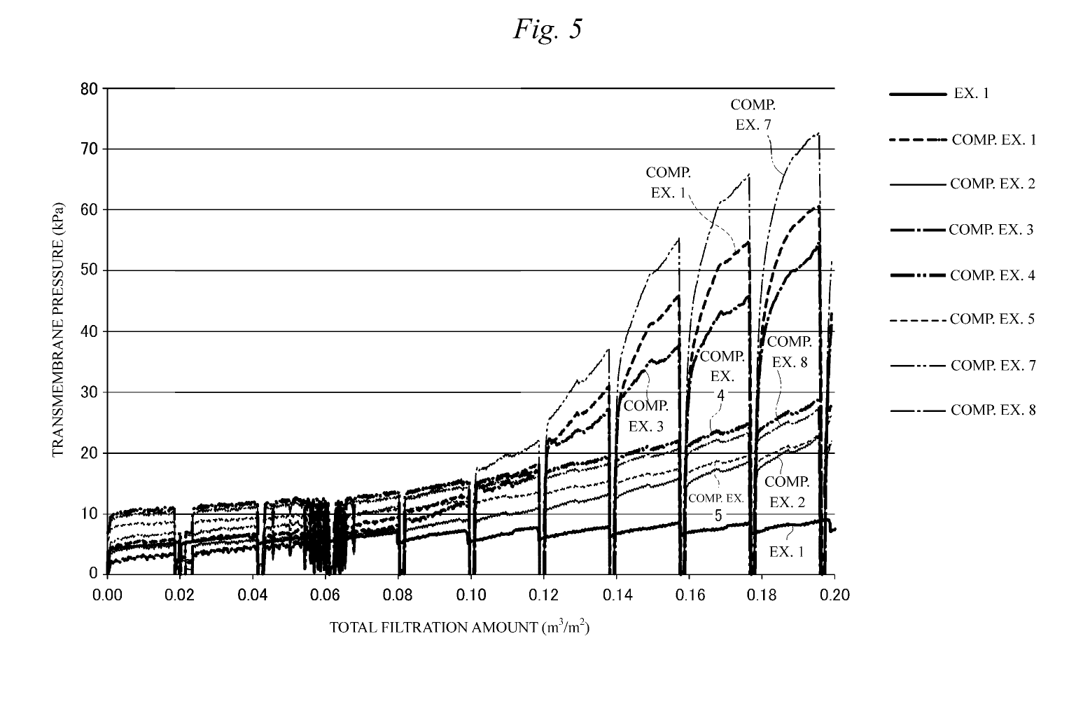

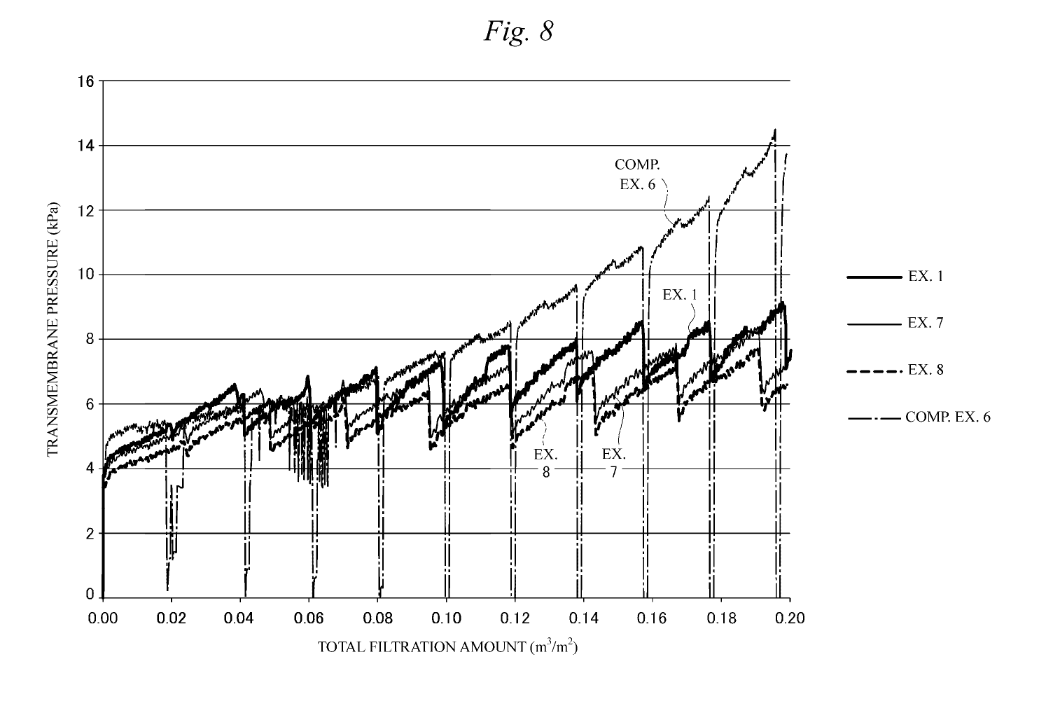

During this period, the difference between the primary side pressure and the secondary side pressure of the separation membrane was observed using the differential pressure meter 27, and the results are illustrated in FIGS. 5 and 8. In FIGS. 5 and 8, the horizontal axes indicate the total filtration amount per membrane surface, and the vertical axes indicate transmembrane pressure. In the operation method of Example 1, compared with Comparative Examples 1 to 8 described below, an increase in the transmembrane pressure was suppressed, and the separation membrane module could be stably operated for a long period of time.

### Comparative Example 1

### Operation in Which the First Water Substitution Step was not Performed

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device and was cross-flow-filtrated. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the filtration step S1 in which the sugar syrup was filtrated from the primary side to the secondary side of the separation membrane in the separation membrane module 8 for 28 minutes at a filtration flux of 1 m³/m²/day was performed. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the acidic chemical solution tank 23 side, the permeated liquid/permeated-liquid flow channel substitution water switching valve 13 was opened on the permeated-liquid flow channel substitution water pump 15 side, the permeated-liquid flow channel substitution water pump 15 was driven, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, the permeated-liquid flow channel substitution water/acidic chemical solution switching valve 11 was closed on the acidic chemical solution tank 23 side and was opened on the permeated-liquid flow channel substitution water feed source 22 side, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first chemical cleaning step S5, and the second water substitution step S6.

During this period, the difference between the primary side pressure and the secondary side pressure of the separation membrane was observed using the differential pressure meter 27, and the results are illustrated in FIG. 5. In the operation method of Comparative Example 1, the transmembrane pressure significantly increased, and it was not possible to continue the operation.

### Comparative Example 2

### Operation in Which the First Chemical Cleaning Step was not Performed

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device and was cross-flow-filtrated. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the filtration step S1 in which the sugar syrup was filtrated from the primary side to the secondary side of the separation membrane in the separation membrane module 8 for 28 minutes at a filtration flux of 1 m³/m²/day was performed. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for seven minutes.

After that, backwashing using a chemical solution was not performed, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, and the second water substitution step S6.

During this period, the difference between the primary side pressure and the secondary side pressure of the separation membrane was observed using the differential pressure meter 27, and the results are illustrated in FIG. 5. In the operation method of Comparative Example 2, the transmembrane pressure increased, and it was not possible to continue the operation.

### Comparative Example 3

### Operation in Which the Second Water Substitution Step was not Performed

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device and was cross-flow-filtrated. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the filtration step S1 in which the sugar syrup was filtrated from the primary side to the secondary side of the separation membrane in the separation membrane module 8 for 28 minutes at a filtration flux of 1.5 m³/m²/day was performed. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step without performing the second water substitution step S6, thereby continuing the filtration of the sugar syrup by repeating the filtration step S1, the first water substitution step S3, and the first chemical cleaning step S5.

During this period, the difference between the primary side pressure and the secondary side pressure of the separation membrane was observed using the differential pressure meter 27, and the results are illustrated in FIG. 5. In the operation method of Comparative Example 3, the transmembrane pressure increased, and it was not possible to continue the operation.

### Example 2

A fruit juice was filtrated using the membrane separation device illustrated in FIG. 4. As a separation membrane, a polyvinylidene fluoride hollow-fiber membrane having a nominal fine pore diameter of 0.05 μm which was used in a microfiltration membrane module “TORAYFIL” (registered trademark) HFS manufactured by Toray Industries, Inc. was cut out, and a hollow-fiber membrane module obtained by accommodating the separation membrane in a molded polycarbonate resin product was used. In addition, the fruit juice had a magnesium ion concentration of 100 ppm, a protein concentration of 5 g/L, and a polysaccharide concentration of 3 g/L.

The fruit juice was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the fruit juice was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the fruit juice was filtrated from the primary side to the secondary side of the separation membrane in the separation membrane module 8 for 28 minutes at a filtration flux of 1 m³/m²/day. At this time, the TOC concentration of the obtained permeated liquid was 400,000 ppm. Subsequently, the cross-flow switching valves 19 and 26 were opened on the separation membrane module 8 side and were closed on the bypass line 25 side, a permeated-liquid flow channel substitution water discharge valve 29 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which the permeated-liquid flow channel of the separation membrane in the separation membrane module 8 was substituted with distilled water was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, the permeated-liquid flow channel substitution water discharge valve 29 was closed, the discharge valve 9 was opened, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, the discharge valve 9 was closed, the permeated-liquid flow channel substitution water discharge valve 29 was opened, and the second water substitution step S6 in which the permeated-liquid flow channel in the separation membrane module 8 was substituted with distilled water was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the fruit juice by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27. As a result, in the method of Example 2, the transmembrane pressure after 0.2 m³ of the fruit juice per square meter of the membrane surface was filtrated increased only up to 7 kPa, and the separation membrane module could be stably operated for a long period of time.

### Example 3

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water pump 15 was halted, the discharge valve 9 and the suspensoid discharge valve 6 were opened, the discharged water/discharged suspensoid liquid storage tank switching valve 33 was opened on a water discharge pipe 34 side, and the suction pump 7 was run, thereby discharging liquid in the separation membrane module.

Subsequently, the suction pump 7 was halted, the discharge valve 9 and the suspensoid discharge valve 6 were closed, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, the permeated-liquid flow channel substitution water pump 15 was run, and the first chemical cleaning step S5 in which 0.1 N hydrochloric acid (35° C.) was caused to flow from the secondary side to the primary side of the separation membrane in the separation membrane module 8 at 1.5 m³/m²/day was performed for two minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27. As a result, in the operation method of Example 3, compared with Example 1, although the first chemical cleaning step was short, when the total filtration amount per membrane area was equal, similar to in Example 1, the transmembrane pressure increased only up to 8 kPa, and the separation membrane module could be stably operated for a long period of time.

### Example 4

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.01 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27. As a result, in the operation method of Example 4, the transmembrane pressure after 0.2 m³ of the sugar syrup per square meter of the membrane surface was filtrated increased only up to 8 kPa, and the separation membrane module could be stably operated for a long period of time.

### Example 5

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.001 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27. As a result, in the operation method of Example 5, the transmembrane pressure after 0.2 m³ of the sugar syrup per square meter of the membrane surface was filtrated increased only up to 9 kPa, and the separation membrane module could be stably operated for a long period of time.

### Example 6

A cellulose-containing biomass-derived sugar syrup was filtrated using a membrane separation device illustrated in FIG. 6. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 6 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 and the permeated-liquid flow channel substitution water/alkaline chemical solution switching valve 35 were opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

Subsequently, the permeated-liquid flow channel substitution water/acidic chemical solution switching valve 11 was closed on the acidic chemical solution tank 23 side, the permeated-liquid flow channel substitution water/alkaline chemical solution switching valve 35 was changed so as to be closed on the permeated-liquid flow channel substitution water feed source 22 side and be opened on the alkaline chemical solution tank 37 side, and the second chemical cleaning step S8 in which an aqueous solution (35° C.) of 0.01 N sodium hydroxide was caused to flow from the secondary side to the primary side of the separation membrane in the separation membrane module 8 at 1.5 m³/m²/day was performed for five minutes.

After that, again, the permeated-liquid flow channel substitution water/alkaline chemical solution switching valve 35 was changed back so as to be closed on the alkaline chemical solution tank 37 side and be opened on the permeated-liquid flow channel substitution water feed source 22 side respectively, and the third water substitution step S9 in which distilled water was caused to flow from the secondary side to the primary side of the separation membrane in the separation membrane module at 1.5 m³/m²/day was performed.

After the end of the third water substitution step S9, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, the second water substitution step S6, the second chemical cleaning step S8, and the third water substitution step S9.

During this period, the difference between the primary side pressure and the secondary side pressure of the separation membrane was observed using the differential pressure meter 27. As a result, in the method of Example 6, the transmembrane pressure after 0.2 m³ of the sugar syrup per square meter of the membrane surface was filtrated little increased from the initial transmembrane pressure and was thus 5 kPa, and the separation membrane module could be stably operated for a long period of time.

### Example 7

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (70° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 8. In FIG. 8, the horizontal axis indicates the total filtration amount per membrane surface, and the vertical axis indicates transmembrane pressure. In the operation method of Example 7, compared with Comparative Example 6 described below, furthermore, an increase in the transmembrane pressure was suppressed, and the separation membrane module could be stably operated for a long period of time.

### Example 8

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (90° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/d ay was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 8. In FIG. 8, the horizontal axis indicates the total filtration amount per membrane surface, and the vertical axis indicates transmembrane pressure. In the operation method of Example 8, compared with Comparative Example 6 described below, furthermore, an increase in the transmembrane pressure was suppressed, and the separation membrane module could be stably operated for a long period of time.

### Example 9

A cellulose-containing biomass-derived sugar syrup was filtrated using the membrane separation device illustrated in FIG. 4. A separation membrane was prepared in the same manner as in Example 1. The cellulose-containing biomass-derived sugar syrup was obtained according to the following order. First, 3,390 g of distilled water and 60 g of strong sulfuric acid were dosed to and were suspended in approximately 2 g of a rice straw and were subjected to an autoclave treatment at 15° C. for 30 minutes using an autoclave (manufactured by Nitto Koatsu Co., Ltd.). After the treatment, a liquid mixture having a pH that had been adjusted to near five using sodium hydroxide was obtained. Subsequently, 250 g of an enzyme aqueous solution containing a total of 0.2 g of TRICHODERMA CELLULOSE (manufactured by Sigma-Aldrich Co. LLC.) and NOVOZYME 188 (aspergillus niger-derived β glycosidase preparation, manufactured by Sigma-Aldrich Co. LLC.) was prepared and dosed to the above-described liquid mixture, and the components were stirred and mixed together at 50° C. for three days, thereby obtaining a sugar syrup to be subjected to filtration. The sugar syrup had a zinc ion concentration of 15 ppm, a protein concentration of 0.05 g/L, and a polysaccharide concentration of 0.05 g/L.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 100 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27. As a result, in the operation method of Example 9, the transmembrane pressure after 0.2 m³ of the sugar syrup per square meter of the membrane surface was filtrated increased only up to 7 kPa, and the separation membrane module could be stably operated for a long period of time.

### Comparative Example 4

A plant-crushed liquid was filtrated using the membrane separation device illustrated in FIG. 4. As a separation membrane, a polyvinylidene fluoride hollow-fiber membrane having a nominal fine pore diameter of 0.05 μm which was used in a microfiltration membrane module “TORAYFIL” (registered trademark) HFS manufactured by Toray Industries, Inc. was cut out, and a hollow-fiber membrane module obtained by accommodating the separation membrane in a molded polycarbonate resin product was used. In addition, the plant-crushed liquid had a magnesium ion concentration of 2,000 ppm, a protein concentration of 10 g/L, and a polysaccharide concentration of 30 g/L.

The obtained plant-crushed liquid was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the plant-crushed liquid was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the plant-crushed liquid was filtrated from the primary side to the secondary side of the separation membrane in the separation membrane module 8 for 28 minutes at a filtration flux of 1 m³/m²/day. At this time, the TOC concentration of the obtained permeated liquid was 500,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the plant-crushed liquid by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 5. In FIG. 5, the horizontal axis indicates the total filtration amount per membrane surface, and the vertical axis indicates transmembrane pressure. In Comparative Example 4, since the TOC concentration of the permeated liquid was high, a sufficient cleaning effect could not be obtained, and it was difficult to continue filtration operation.

### Comparative Example 5

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.0001 N hydrochloric acid (35° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 5. In FIG. 5, the horizontal axis indicates the total filtration amount per membrane surface, and the vertical axis indicates transmembrane pressure. In Comparative Example 5, a sufficient cleaning effect could not be obtained, and it was difficult to continue filtration operation.

### Comparative Example 6

A cellulose-containing biomass-derived sugar syrup was filtrated using the membrane separation device illustrated in FIG. 4. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (20° C.) was caused to flow from the secondary side to the primary side of the separation membrane in the separation membrane module 8 at 1.5 m³/m²/day was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 8. In FIG. 8, the horizontal axis indicates the total filtration amount per membrane surface, and the vertical axis indicates transmembrane pressure. In Comparative Example 6, compared with Examples 1, 7, and 8, a sufficient cleaning effect could not be obtained, and the transmembrane pressure was rapidly increased.

### Comparative Example 7

A cellulose-containing biomass-derived sugar syrup was filtrated using a membrane separation device illustrated in FIG. 6. A separation membrane and the cellulose-containing biomass-derived sugar syrup were prepared in the same manner as in Example 1.

The obtained sugar syrup was fed into the liquid-to-be-filtrated feed tank 1 in the separation membrane device of FIG. 6 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 25,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 and the permeated-liquid flow channel substitution water/alkaline chemical solution switching valve 35 were opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/alkaline chemical solution switching valve 35 was changed so as to be closed on the permeated-liquid flow channel substitution water feed source 22 side and be opened on the alkaline chemical solution tank 37 side respectively, and the second chemical cleaning step S8 in which an aqueous solution (35° C.) of 0.01 N sodium hydroxide was caused to flow from the secondary side to the primary side of the separation membrane in the separation membrane module 8 at 1.5 m³/m²/day was performed for five minutes.

After that, again, the permeated-liquid flow channel substitution water/alkaline chemical solution switching valve 35 was changed back so as to be closed on the alkaline chemical solution tank 37 side and be opened on the permeated-liquid flow channel substitution water feed source 22 side respectively, and the third water substitution step S9 in which distilled water was caused to flow from the secondary side to the primary side of the separation membrane in the separation membrane module 8 at 1.5 m³/m²/day was performed.

After the end of the third water substitution step S9, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the second chemical cleaning step S8, and the third water substitution step S9.

During this period, the difference between the primary side pressure and the secondary side pressure of the separation membrane was observed using the differential pressure meter 27, and the results are illustrated in FIG. 5. In FIG. 5, the horizontal axis indicates the total filtration amount per membrane surface, and the vertical axis indicates transmembrane pressure. In Comparative Example 7, compared with Example 1, a sufficient cleaning effect could not be obtained, and it was difficult to continue filtration operation.

### Comparative Example 8

A cellulose-containing biomass-derived sugar syrup was filtrated using the membrane separation device illustrated in FIG. 4. A separation membrane was prepared in the same manner as in Example 1. The cellulose-containing biomass-derived sugar syrup was obtained according to the following order. First, 2,940 g of distilled water and 60 g of strong sulfuric acid were dosed to and were suspended in 400 g of a rice straw and were subjected to an autoclave treatment at 15° C. for 30 minutes using an autoclave (manufactured by Nitto Koatsu Co., Ltd.). After the treatment, a liquid mixture having a pH that had been adjusted to near five using sodium hydroxide was obtained. Subsequently, 250 g of an enzyme aqueous solution containing a total of 25 g of TRICHODERMA CELLULOSE (manufactured by Sigma-Aldrich Co. LLC.) and NOVOZYME 188 (aspergillus niger-derived β glycosidase preparation, manufactured by Sigma-Aldrich Co. LLC.) was prepared and dosed to the above-described liquid mixture, the components were stirred and mixed together at 50° C. for three days, and supernatants generated after leaving the mixture for a while were obtained. The obtained supernatants were caused to flow through a cation exchange resin and then were subjected to filtration. The sugar syrup had a magnesium ion concentration of 0 ppm, a protein concentration of 9 g/L, and a polysaccharide concentration of 4 g/L.

The obtained sugar syrup was fed into the liquid-to-be-filtrated feed tank I in the separation membrane device of FIG. 4 and was membrane-filtrated. As the filtration, cross-flow filtration was performed. First, as the filtration step S1, the filtration valve 4 was opened, the cross-flow filtration circulation pump 18 was driven, the sugar syrup was fed to the separation membrane module 8 so that the membrane surface linear rate reached 0.3 m/sec, and concentrated liquid that had not been membrane-filtrated was circulated so as to return to the liquid-to-be-filtrated feed tank 1 through the cross-flow switching valve 26. At the same time, the permeated liquid/permeated-liquid flow channel substitution water switching valve 13 was opened on the permeated liquid tank 21 side, and the sugar syrup was filtrated from the primary side to the secondary side of the separation membrane in the separation membrane module 8 for 28 minutes at a filtration flux of 1 m³/m²/day. At this time, the TOC concentration of the obtained permeated liquid was 21,000 ppm. Subsequently, the cross-flow switching valves 19 and 26 were closed on the separation membrane module 8 side and were opened on the bypass line 25 side, the discharge valve 9 was opened, the permeated-liquid flow channel substitution water/acidic chemical solution switching valve 11 was opened on the permeated-liquid flow channel substitution water feed source 22 side, the permeated liquid/permeated-liquid flow channel substitution water switching valve 13 was opened on the permeated-liquid flow channel substitution water pump 15 side, the permeated-liquid flow channel substitution water pump 15 was driven, and the first water substitution step S3 in which distilled water was caused to flow from the secondary side to the primary side of the separation membrane in the separation membrane module 8 at 1.5 m³/m²/day was performed for two minutes.

Subsequently, the permeated-liquid flow channel substitution water/acidic chemical solution switching valve 11 was changed so as to be closed on the permeated-liquid flow channel substitution water feed source 22 side and be opened on the acidic chemical solution tank 23 side respectively, and the first chemical cleaning step S5 in which 0.1 N hydrochloric acid (35° C.) was caused to flow from the secondary side to the primary side of the separation membrane in the separation membrane module 8 at 1.5 m³/m²/d ay was performed for five minutes.

After that, again, the permeated-liquid flow channel substitution water/acidic chemical solution switching valve 11 was changed back so as to be closed on the acidic chemical solution tank 23 side and be opened on the permeated-liquid flow channel substitution water feed source 22 side respectively, and the second water substitution step S6 in which distilled water was caused to flow from the secondary side to the primary side of the separation membrane in the separation membrane module 8 at 1.5 m³/m²/day was performed.

After the end of the second water substitution step S6, the permeated-liquid flow channel substitution water pump 15 was halted, the discharge valve 9 was closed, and the permeated liquid/permeated-liquid flow channel substitution water switching valve 13 was opened on the permeated liquid tank 21 side, and the process was returned again to the filtration step S1, thereby continuing the filtration of the sugar syrup by repeating the filtration step S1, the first water substitution step S3, the first chemical cleaning step S5, and the second water substitution step S6.

During this period, the difference between the primary side pressure and the secondary side pressure of the separation membrane was observed using the differential pressure meter 27, and the results are illustrated in FIG. 5. In FIG. 5, the horizontal axis indicates the total filtration amount per membrane surface, and the vertical axis indicates transmembrane pressure. In the operation method of Comparative Example 8, compared with Example 1, a sufficient cleaning effect could not be obtained, and it was difficult to continue filtration operation.

While the invention has been described in detail and with reference to specific embodiments thereof, it will be apparent to one skilled in the art that various changes and modifications can be made therein without departing from the spirit and scope thereof. The present application is based on a Japanese Patent Application filed on Mar. 24, 2014 (Japanese Patent Application No. 2014-060640), the contents of which are incorporated herein by reference.

### INDUSTRIAL APPLICABILITY

According to the present invention, in the membrane filtration operation of liquid to be filtrated containing organic substances at a high concentration, clogging caused by modified substances of the organic substances is suppressed by substituting the permeated-liquid flow channel with water before and after the backwashing step using a chemical solution, the cleaning effect of the chemical solution is sufficiently exhibited, and long-term stable membrane filtration operation can be realized, and thus the present invention is widely used in food, biotechnology and medicinal fields in which membrane filtration processes for liquid containing a large amount of organic substances are employed, and it becomes possible to improve the efficiency in the production of membrane filtration products or reduce costs.

### DESCRIPTION OF REFERENCE NUMERALS AND SIGNS

1 Liquid-To-Be-Filtrated Feed Tank
2 Filtration Pump
3 Pipe
4 Filtration Valve
6 Suspensoid Discharge Valve
7 Suction Pump
8 Separation Membrane Module
9 Discharge Valve
10 Pipe
11 Permeated-Liquid Flow Channel Substitution Water/Acidic Chemical Solution Switching Valve
13 Permeated Liquid/Permeated-Liquid Flow Channel Substitution Water Switching Valve
15 Permeated-Liquid Flow Channel Substitution Water Pump
16 Permeated-Liquid Flow Channel Substitution Water Pipe
17 Acidic Chemical Solution Pipe
18 Cross-Flow Filtration Circulation Pump
19 Cross-Flow Switching Valve
20 Control Device
21 Permeated Liquid Tank
22 Permeated-Liquid Flow Channel Substitution Water Feed Source
23 Acidic Chemical Solution Tank
24 Discharged Suspensoid Liquid Storage Tank
25 Bypass Line
26 Cross-Flow Switching Valve
27 Differential Pressure Meter
28 Permeated-Liquid Flow Channel Substitution Water Discharge Pipe
29 Permeated-Liquid Flow Channel Substitution Water Discharge Valve
30 Permeated-Liquid Flow Channel Substitution Water Discharge Tank
31 Discharged Suspensoid Liquid Reflux Pump
32 Discharged Suspensoid Liquid Reflux Pipe
33 Discharged Water/Discharged Suspensoid Liquid Storage Tank Switching Valve
34 Water Discharge Pipe
35 Permeated-Liquid Flow Channel Substitution Water/Alkaline Chemical Solution Switching Valve
36 Alkaline Chemical Solution Pipe
37 Alkaline Chemical Solution Tank
38 Acidic Medical Solution Raw Liquid Pipe
39 Acidic Medical Solution Raw Liquid Pump
40 Acidic Medical Solution Raw Liquid Tank
41 Alkaline Medical Solution Raw Liquid Pipe
42 Alkaline Medical Solution Raw Liquid Pump
43 Alkaline Medical Solution Raw Liquid Tank
44 Permeated-Liquid Flow Channel

1-11. (canceled)

12. A method for operating a separation membrane module comprising a separation membrane having a first face and a second face, a liquid-to-be-filtrated flow channel along which liquid to be filtrated which is to be fed to the first face flows, and a permeated-liquid flow channel along which permeated liquid obtained from the second face flows, the method comprising:
a filtration step of obtaining permeated liquid containing components that become insoluble when coming into contact with acids from the second face of the separation membrane by feeding liquid to be filtrated to the liquid-to-be-filtrated flow channel;
a first water substitution step of substituting liquid in the permeated-liquid flow channel with water, after the filtration step;
a first chemical cleaning step of performing backwashing by causing an acidic chemical solution to flow from the second face toward the first face of the separation membrane, after the first water substitution step; and
a second water substitution step of substituting liquid in the permeated-liquid flow channel with water, after the first chemical cleaning step.

13. The method for operating a separation membrane module according to claim 12, wherein the first water substitution step includes causing water to flow from the second face toward the first face of the separation membrane.

14. The method for operating a separation membrane module according to claim 12, further comprising:
a step of discharging liquid in the permeated-liquid flow channel, before the first chemical cleaning step.

15. The method for operating a separation membrane module according to claim 12, wherein the permeated liquid has a total organic carbon (TOC) concentration of 100 ppm or higher and 400,000 ppm or lower.

16. The method for operating a separation membrane module according to claim 12, wherein the permeated liquid has the total organic carbon (TOC) concentration of 100 ppm or higher and 400,000 ppm or lower, the liquid to be filtrated contains 100 g/L to 650 g/L of an organic substance, and the total organic carbon (TOC) concentration of the water to be used in the first water substitution step and the second water substitution step is 100 ppm or lower.

17. The method for operating a separation membrane module according to claim 12, wherein the permeated liquid contains at least one substance selected from the group consisting of protein, polysaccharides and aromatic compounds.

18. The method for operating a separation membrane module according to claim 12, wherein the liquid to be filtrated contains divalent or higher metal ions and contains at least one of polysaccharides and aromatic compounds.

19. The method for operating a separation membrane module according to claim 18, wherein, in the liquid to be filtrated, the metal ions and the at least one of polysaccharides and aromatic compounds form a complex.

20. The method for operating a separation membrane module according to claim 12, wherein the acidic chemical solution is an aqueous solution which contains at least one compound selected from the group consisting of hydrochloric acid, nitric acid, sulfuric acid, phosphoric acid, formic acid, acetic acid, propionic acid, butyric acid, citric acid, oxalic acid, ascorbic acid and lactic acid, and has a pH of 1 or higher and 3 or lower.

21. The method for operating a separation membrane module according to claim 12, further comprising:
a second chemical cleaning step of causing an alkaline chemical solution to flow from the second face toward the first face of the separation membrane, after the second water substitution step; and
a third water substitution step of substituting liquid in the permeated-liquid flow channel with water, after the second chemical cleaning step.

22. The method for operating a separation membrane module according to claim 12, wherein temperatures of the water to be used in the first water substitution step and the second water substitution step and the chemical solution to be used in the first chemical cleaning step are 35° C. or higher and 90° C. or lower.

23. A device for performing the method for operating a separation membrane module according to claim 12.
